(19) United States
(12) Patent Application Publication
(10) Pub. No.: US 2018/0061553 A1
(43) Pub. Date: Mar. 1, 2018

(54) CHIP ELECTRONIC COMPONENT INCLUDING STRESS BUFFER LAYER

(71) Applicant: SAMSUNG ELECTRO-MECHANICS CO., LTD., Suwon-si (KR)

(72) Inventors: Hyung Jin JEON, Suwon-si (KR); Je Ik MOON, Suwon-si (KR); Jung Wook SEO, Suwon-si (KR); Young Seuck YOO, Suwon-si (KR); Seon Woo OH, Suwon-si (KR); Woo Jin LEE, Suwon-si (KR)

(21) Appl. No.: 15/629,259

(22) Filed: Jun. 21, 2017

(30) Foreign Application Priority Data
Sep. 1, 2016 (KR) 10-2016-0112391

(51) Int. Cl. H01F 27/28; H01F 27/255; H01F 27/29

(52) U.S. Cl. CPC H01F 27/2804; H01F 27/292; H01F 27/255

(57) ABSTRACT

A chip electronic component includes a body including a coil portion disposed therein and a magnetic metallic powder, and a stress buffer layer disposed on a surface of the body. A Young's modulus of the stress buffer layer is less than that of the body.

### CROSS-REFERENCE TO RELATED APPLICATION

This application claims the benefit of priority to Korean Patent Application No. 10-2016-0112391, filed on Sep. 1, 2016 with the Korean Intellectual Property Office, the entire disclosure of which is incorporated herein by reference.

### BACKGROUND

### 1. Technical Field

The present disclosure relates to a chip electronic component that includes a stress buffer layer.

### 2. Description of Related Art

An inductor is a type of chip electronic component, and is a representative passive device that may constitute a component in an electronic circuit, along with a resistor and a capacitor, to remove noise therefrom.

Thin-film type power inductors are manufactured by forming a coil portion by means of plating, hardening a magnetic powder-resin compound formed by mixing magnetic powder and resin with each other to form a body, and forming external electrodes on outer portions of the body.

In general, power inductors may have a structure in which a magnetic compound surrounds a coil.

However, a mismatch among coefficients of thermal expansion (CTE) of various materials included in a package, due to heat generated by external electrodes, may occur.

Specifically, an epoxy mold compound (EMC), which is a material of a body included in the package, may apply stress to the power inductor disposed in the package, thereby reducing reliability of the power inductor.

### SUMMARY

An aspect of the present disclosure may provide a chip electronic component having improved reliability.

According to an aspect of the present disclosure, a chip electronic component may include: a body including a coil portion disposed therein and a magnetic metallic powder; and a stress buffer layer disposed on a surface of the body. A Young's modulus of the stress buffer layer may be less than that of the body.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view illustrating coil portions of a chip electronic component according to an exemplary embodiment;

FIG. 2 is a cross-sectional view taken along line I-I′ of FIG. 1;

FIG. 3 is a cross-sectional view taken along line II-II′ of FIG. 1;

FIG. 4 is a cross-sectional view of a chip electronic component, on an L-T plane, according to another exemplary embodiment;

FIG. 5 is a graph of a comparison between crack suppression effects, depending on materials of a stress buffer layer included in a chip electronic component, according to an exemplary embodiment; and

FIG. 6 is a graph of a comparison between stress reduction effects, according to thicknesses of a stress buffer layer included in a chip electronic component, according to an exemplary embodiment.

### DETAILED DESCRIPTION

Hereinafter, exemplary embodiments of the present disclosure will be described with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element, or other elements intervening therebetween may be present. In contrast, when an element is referred to as being “directly on, ” “directly connected to,” or “directly coupled to” another element, there may be no other elements or layers intervening therebetween. Like numerals refer to like elements throughout. As used herein, the term “and/or” includes any and all combinations of one or more of the associated, listed items.

It will be apparent that, although the terms ‘first,’ ‘second,’ ‘third,’ etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship relative to another element(s), as shown in the figures. It will be understood that the spatially relative terms are intended to encompass different orientations of the device in use or operation, in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein describes particular embodiments only, and the present disclosure is not limited thereby. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape resulting from manufacturing. The following embodiments may also be constituted alone or as a combination of several.

The contents of the present disclosure described below may have a variety of configurations, and only a required configuration is proposed herein, but the present disclosure is not limited thereto.

### Chip Electronic Component

Hereinafter, a chip electronic component according to an exemplary embodiment will be described with regard to, in particular, a thin-film type inductor, but the present disclosure is not limited thereto.

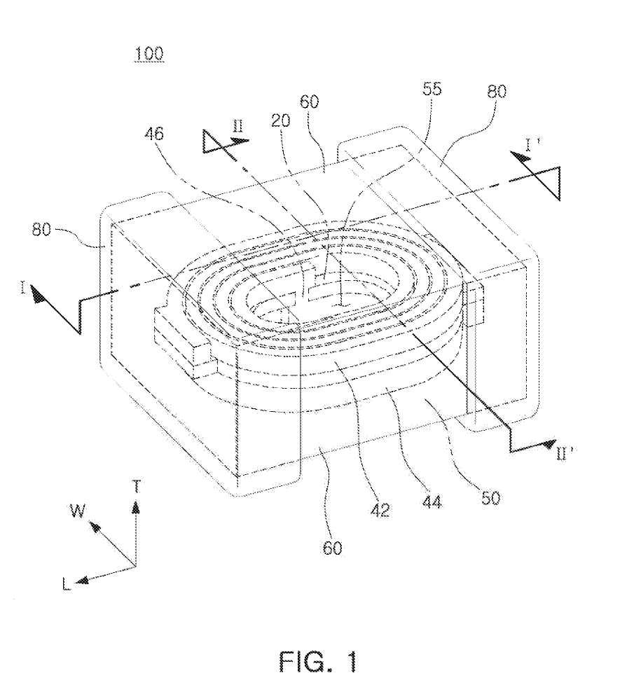

FIG. 1 is a schematic perspective view illustrating coil portions of a chip electronic component, according to an exemplary embodiment.

Referring to FIG. 1, a thin-film type inductor 100, which may be used in a power line of a power supply circuit, is disclosed as an example of the chip electronic component.

A chip electronic component 100, according to the present exemplary embodiment, may include a body 50, coil portions 42 and 44 embedded in the body 50, a stress buffer layer 60 disposed on a surface of the body 50, and external electrodes 80 disposed on outer portions of the body 50 to be electrically connected to the coil portions 42 and 44.

In the chip electronic component 100 according to the present exemplary embodiment, ‘length,’ ‘width,’ and ‘thickness’ directions may be defined as ‘L,’ ‘W,’ and ‘T’ directions of FIG. 1, respectively.

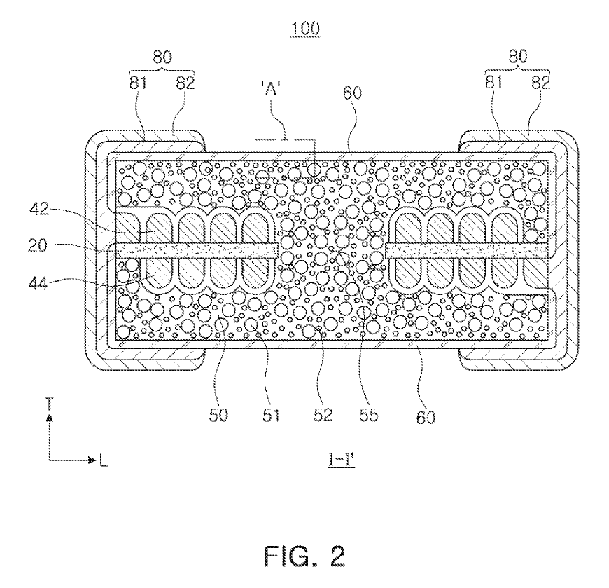

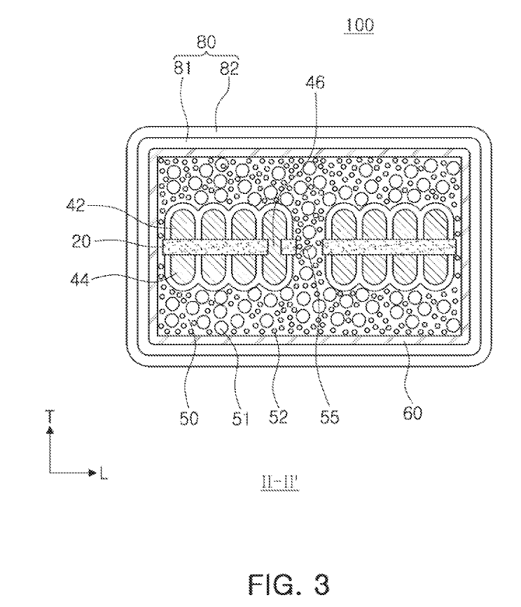

FIG. 2 is a cross-sectional view taken along line I-I′ of FIG. 1, and FIG. 3 is a cross-sectional view taken along line II-II′ of FIG. 1.

Referring to FIGS. 2 and 3, the body 50 may include first and second magnetic metallic powders 51 and 52.

Examples of the first and second magnetic metallic powders 51 and 52 may include at least one of iron (Fe), silicon (Si), chromium (Cr), aluminum (Al), and nickel (Ni). The first and second magnetic metallic powders 51 and 52 may include, but are not limited to, for example, iron-silicon-boron-chromium (Fe—Si—B—Cr)-based amorphous metallic particles.

The body 50 may further include a thermosetting resin, and the first and second magnetic metallic powders 51 and 52 may be included in a thermosetting resin, such as an epoxy resin or a polyimide resin, to be dispersed therein.

In order to increase a filling rate of magnetic metallic powders included in the body 50, two types of first and second magnetic metallic powders 51 and 52, having different grain sizes, may be mixed at a certain ratio.

A magnetic metallic powder having high permeability and a large grain size may be used to obtain a high level of inductance in a predetermined unit volume. A magnetic metallic powder having a smaller grain size may be mixed with the magnetic metallic powder having the large grain size to increase the filling rate, thus securing high permeability and preventing degradation of efficiency due to magnetic loss (core loss) at a high frequency and a high level of current.

The coil portion 42 having a coil pattern may be formed on a first surface of an insulating substrate 20 disposed in the body 50, and the coil portion 44 having a coil pattern may be formed on a second surface of the insulating substrate 20, opposite the first surface.

The insulating substrate 20 may be formed as, for example, a polypropylene glycol (PPG) substrate, a ferrite substrate, or a soft, magnetic, metallic substrate.

A hole may be formed in a central portion of the insulating substrate 20, and may be filled with a magnetic metallic powder to form a core portion 55. By the formation of the core portion 55, inductance may be increased.

The coil portions 42 and 44 may be formed as coil patterns having a spiral shape. The coil portions 42 and 44, formed on the first and second surfaces of the insulating substrate 20, may be electrically connected to each other through a via 46 formed in the insulating substrate 20.

The coil portions 42 and 44 and the via 46 may include a metal having excellent electrical conductivity, for example, silver (Ag), palladium (Pd), aluminum (Al), nickel (Ni), titanium (Ti), gold (Au), copper (Cu), platinum (Pt), or alloys thereof.

One end of the coil portion 42, formed on the first surface of the insulating substrate 20, may be exposed toward a first end surface in the L direction of the body 50, and one end of the coil portion 44, formed on the second surface of the insulating substrate 20, may be exposed toward a second end surface in the L direction of the body 50 opposite the first end surface.

The external electrodes 80 may be formed on the first and second end surfaces in the L direction of the body 50, so as to be electrically connected to the coil portions 42 and 44 that are exposed toward the first and second end surfaces in the L direction.

As illustrated in FIG. 2, portions of the stress buffer layer 60 may be removed so that the ends of the coil portions 42 and 44 may be electrically connected to the external electrodes 80.

Each of the external electrodes 80 may include a conductive resin layer 81 and a plating layer 82, formed on the conductive resin layer 81.

The conductive resin layer 81 may include at least one conductive metal including at least one of copper (Cu), nickel (Ni), and silver (Ag), and a thermosetting resin.

A thermosetting resin included in the conductive resin layer 81, and a thermosetting resin included in the body 50 may be identical, and the body 50 and the conductive resin layer 81 may both include, for example, an epoxy resin.

Adhesive strengths of the body 50 and the external electrodes 80 may be increased by using an identical thermosetting resin, for example, an epoxy resin, in forming the thermosetting resins included in the body 50 and the conductive resin layer 81.

The plating layer 82 may include at least one of nickel (Ni), copper (Cu), and tin (Sn), and, for example, a nickel (Ni) layer and a tin (Sn) layer may be sequentially formed in the plating layer 82.

In a plating process of forming the plating layer 82, a plating spreading defect may occur, in which a plating layer is formed on coarse particles of a magnetic metallic powder exposed to the surface of the body 50.

However, in the present exemplary embodiment, the stress buffer layer 60 may be formed on the surface of the body 50, to prevent the plating spreading defect caused by the coarse particles of the magnetic metallic powder from occurring.

Referring to FIGS. 2 and 3, the stress buffer layer 60 according to an embodiment may be formed on lateral surfaces opposing each other in the T direction of the body 50, lateral surfaces opposing each other in the W direction of the body 50, and the first and second end surfaces opposing each other in the L direction of the body 50.

Here, portions of the stress buffer layer 60 may be removed by grinding, so that the ends of the coil portions 42 and 44 may be electrically connected to the external electrodes 80.

In general, power inductors may have a structure in which a magnetic compound surrounds a coil.

However, a mismatch among coefficients of thermal expansion (CTE) of various materials included in a package, due to heat generated by external electrodes, may occur.

That is, an epoxy mold compound (EMC), which is a material of a body included in the package, may apply stress to the power inductor disposed in the package, thus reducing reliability of the power inductor.

According to the present exemplary embodiment, the stress buffer layer 60 may be disposed on the surface of the body 50 included in the chip electronic component 100 to absorb stress generated by a mismatch between coefficients of thermal expansion of the stress buffer layer 60 and an EMC, which is a material of the body 50 included in a package, thus increasing the reliability of the chip electronic component 100.

According to an exemplary embodiment, a Young's modulus of the stress buffer layer 60 may be less than that of the body 50.

The stress buffer layer 60 may be disposed on the surface of the body 50, and may be formed using a material having a Young's modulus less than that of the body 50. Thus, when the chip electronic component 100 is disposed in the package, the stress buffer layer 60 having a low Young's modulus may absorb stress generated by a mismatch between coefficients of thermal expansion of the stress buffer layer 60 and the EMC, to prevent stress from being applied to an interior of the chip electronic component 100, thus increasing the reliability of the chip electronic component 100.

In detail, the Young's modulus of the stress buffer layer may be less than or equal to 10 GPa.

The stress buffer layer 60 may include a material having a Young's modulus less than or equal to 10 GPa, and may be disposed on the surface of the body 50, to reduce about 20% of the stress applied to the chip electronic component 100, thus suppressing cracking of the chip electronic component 100 and increasing the reliability thereof.

When the Young's modulus of the stress buffer layer 60 exceeds 10 GPa, a stress reduction effect may be low, and thus a reliability improvement effect may be insufficient.

A method of disposing the stress buffer layer 60 on the surface of the body 50 is not particularly limited, and may be performed using, for example, a coating process.

An average thickness of the stress buffer layer 60 may be within a range of 10 μm to 50 μm, and, more preferably, within a range of 10 μm to 20 μm.

The average thickness of the stress buffer layer 60 may be adjusted to be within a range of 10 μm to 50 μm, and, more preferably, within a range of 10 μm to 20 μm, thus providing an excellent stress reduction effect.

When an average thickness of the stress buffer layer 60 is less than 10 μm, the stress reduction effect may be low, and the plating spreading defect may occur, due to exposure of the magnetic metallic powder.

When an average thickness of the stress buffer layer 60 exceeds 20 μm or 50 μm, the volume of the body 50 may be reduced, resulting in a significant reduction in inductance.

The stress buffer layer 60 may further include an insulating filler, used to provide insulating properties.

The insulating filler may include at least one of silica (SiO₂), titanium dioxide (TiO₂), alumina, glass, and a barium titanate powder.

The insulating filler may have a spherical shape or a flake shape, in order to increase density.

The stress buffer layer 60 may include 100 wt % or less of the insulating filler, based on 100 wt % of the stress buffer layer 60.

A thickness deviation of the stress buffer layer 60 may be 2 μm or less.

The stress buffer layer 60 may be uniformly formed on the coarse particles of the magnetic metallic powder, as well as on a portion of the surface of the body 50, in which fine particles of the magnetic metallic powder and the thermosetting resin are provided, thus satisfying a requirement for the thickness deviation to 2 μm or less.

When the thickness deviation of the stress buffer layer 60 exceeds 2 μm, the coarse particles of the magnetic metallic powder may be exposed, so that a plating spreading defect may occur.

As in an embodiment, when a magnetic metallic powder having a large grain size and a magnetic metallic powder having a small grain size are mixed, the surface roughness of a body may be increased. In particular, in a process of grinding a body cut into an individual chip size, the magnetic metallic powder having the large grain size may protrude from a surface of the body, and an insulating coating layer disposed on a protruding portion of the magnetic metallic powder may be removed from the protruding portion.

Accordingly, when a plating layer of each of the external electrodes is formed, a plating spreading defect, in which a plating layer is formed on the protruding portion of the magnetic metallic powder from which the insulating coating layer is removed, may occur.

In an embodiment, the stress buffer layer 60 may be formed on the surface of the body 50 to prevent the plating spreading defect. The stress buffer layer 60 may also function as a plating spreading defect prevention layer by covering the protruding portion of the magnetic metallic powder protruding from the surface of the body 50.

The body 50, according to the present embodiment, may include the first magnetic metallic powder 51 and the second magnetic metallic powder 52 having a D50 less than that of the first magnetic metallic powder 51.

The first magnetic metallic powder 51, having the D50 greater than that of the second magnetic metallic powder 52, may have higher permeability, and the first and second magnetic metallic powders 51 and 52 may be mixed to increase the filling rate, thus further increasing permeability, and improving Q characteristics.

The first magnetic metallic powder 51 may have a D50 within a range of 18 μm to 22 μm, and the second magnetic metallic powder 52 may have a D50 within a range of 2 μm to 4 μm.

The D50 may be measured using a particle diameter/particle size distribution measurement device using a laser diffraction scattering method.

A particle diameter of the first magnetic metallic powder 51 may be within a range of 11 μm to 53 μm, and a particle diameter of the second magnetic metallic powder 52 may be within a range of 0.5 μm to 6 μm.

The body 50 may include the first magnetic metallic powder 51, having a large average particle diameter, and the second magnetic metallic powder 52, having an average particle diameter smaller than that of the first magnetic metallic powder 51.

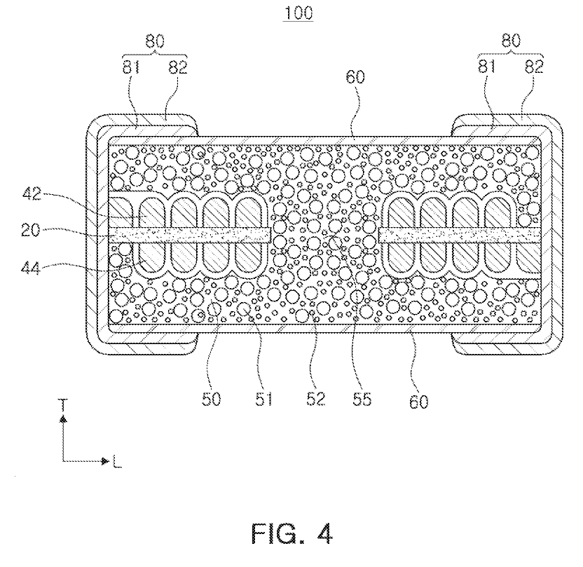

FIG. 4 is a cross-sectional view of a chip electronic component on an L-T plane according to another exemplary embodiment.

Referring to FIG. 4, a stress buffer layer 60 according to the present exemplary embodiment may be disposed on only lateral surfaces in a width direction of a body 50 and lateral surfaces in a thickness direction T of the body 50.

A plating spreading defect, caused by exposure of coarse particles of a magnetic metallic powder, may occur on first and second end surfaces in a length direction L of the body 50, the lateral surfaces in the T direction of the body 50, and the lateral surfaces in the width direction of the body 50, but may mainly occur on the lateral surfaces in the T direction of the body 50.

Thus, the stress buffer layer 60 for preventing the plating spreading defect may be formed on the lateral surfaces in the T direction of the body 50.

In addition, according to the present exemplary embodiment, when the stress buffer layer 60 is disposed on only the lateral surfaces in the width direction of the body 50 and the lateral surfaces in the T direction of the body 50, the stress buffer layer 60 may not be provided on the lateral surfaces in the L direction of the body 50, to increase the volume of the body 50, thus increasing inductance. That is, the stress buffer layer may not be disposed on lateral surfaces opposing each other in a length direction of the body. In another embodiment, the stress buffer may not be disposed on lateral surfaces opposing each other in a length direction of the body, and the stress buffer may not be disposed on lateral surfaces opposing each other in a width direction of the body.

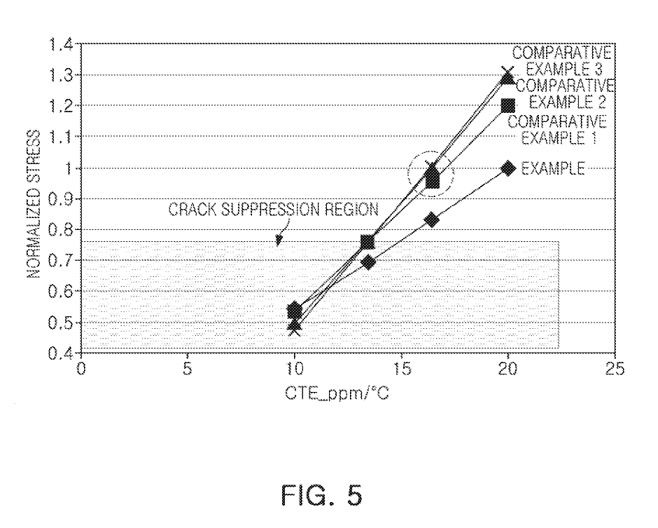

FIG. 5 is a graph of a comparison between crack suppression effects, depending on materials of a stress buffer layer included in a chip electronic component, according to an exemplary embodiment.

Referring to FIG. 5, stress buffer layers according to an exemplary embodiment may include materials as Example and Comparative Examples 1 to 3, and the stress buffer layer as the Example may have a Young's modulus of 10 GPa. The stress buffer layers as Comparative Examples 1 to 3 may have Young's moduli of 20.0 GPa, 33.0 GPa, and 40.0 GPa, respectively.

As illustrated in FIG. 5, when the stress buffer layer as the Example includes the material having the Young's modulus of 10 GPa, the stress buffer layer may provide about 20% of a stress reduction effect, thus suppressing cracking of the chip electronic component.

In the case of Comparative Examples 1 to 3, the stress reduction effect may be insufficient.

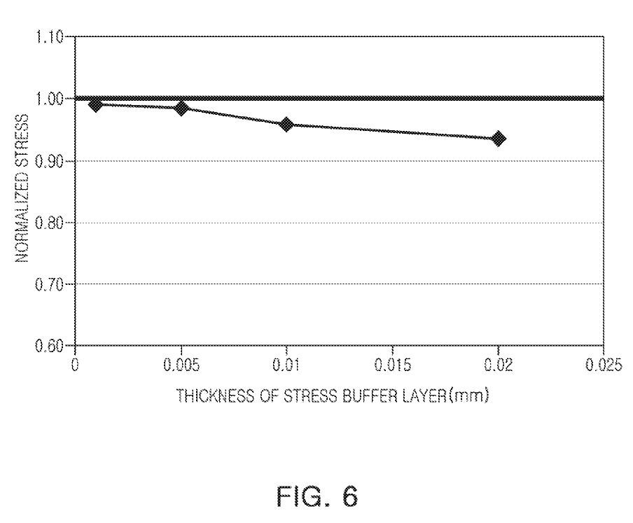

FIG. 6 is a graph of a comparison between stress reduction effects according to thicknesses of a stress buffer layer included in a chip electronic component, according to an exemplary embodiment.

Referring to FIG. 6, the thick, solid line indicated by a straight line may represent a state of normalized stress 1.0. In this state, a stress buffer layer may not be provided. A solid line disposed below the thick, solid line may indicate a degree of a reduction in stress, according to the thicknesses of the stress buffer layer.

As illustrated in FIG. 6, a stress reduction effect may be provided in a region in which a thickness of the stress buffer layer is greater than or equal to 10 μm, and about 7% of the stress reduction effect may be obtained at a thickness of about 20 μm.

When a thickness of the stress buffer layer is less than 10 μm, the stress reduction effect may be insufficient, and when the thickness is significantly reduced, a magnetic metallic powder of a body may be exposed, and thus, the plating spreading defect may occur.

Except for the above description, repeated descriptions of the features of the chip electronic component according to the foregoing exemplary embodiment will be omitted here.

As set forth above, according to an exemplary embodiment, a stress buffer layer may be disposed on a surface of a body included in a chip electronic component to absorb stress generated by a mismatch between coefficients of thermal expansion (CTE) of the stress buffer layer and an epoxy mold compound (EMC), which is a material of the body included in a package, thus improving reliability of the chip electronic component.

Further, a stress buffer layer may be disposed on a surface of a body, thus preventing the plating spreading defect that may occur on a surface of a chip electronic component when external electrodes are formed.

While exemplary embodiments have been shown and described above, it will be apparent to those skilled in the art that modifications and variations could be made without departing from the scope of the present invention, as defined by the appended claims.

What is claimed is:

1. A chip electronic component comprising:
a body including a coil portion disposed therein and a magnetic metallic powder; and
a stress buffer layer disposed on a surface of the body,
wherein a Young's modulus of the stress buffer layer is less than a Young's modulus of the body.

2. The chip electronic component of claim 1, wherein the Young's modulus of the stress buffer layer is less than or equal to 10 GPa.

3. The chip electronic component of claim 1, wherein the body includes an epoxy resin.

4. The chip electronic component of claim 1, wherein an average thickness of the stress buffer layer is within a range of 10 μm to 50 μm.

5. The chip electronic component of claim 4, wherein an average thickness of the stress buffer layer is within a range of 10 μm to 20 μm.

6. The chip electronic component of claim 1, wherein a thickness deviation of the stress buffer layer is less than or equal to 2 μm.

7. The chip electronic component of claim 1, wherein the stress buffer layer further includes an insulating filler.

8. The chip electronic component of claim 1, wherein the stress buffer layer is disposed on an entirety of a surface of the body.

9. The chip electronic component of claim 1, wherein the stress buffer layer is disposed on lateral surfaces opposing each other in a width direction of the body and on lateral surfaces opposing each other in a thickness direction of the body.

10. The chip electronic component of claim 1, wherein the stress buffer layer is not disposed on lateral surfaces opposing each other in a length direction of the body.

11. The chip electronic component of claim 1, wherein the stress buffer layer is not disposed on lateral surfaces opposing each other in a length direction of the body and is not disposed on lateral surfaces opposing each other in a width direction of the body.

12. The chip electronic component of claim 1, further comprising:
external electrodes disposed on outer portions of the body and electrically connected to ends of the coil portion,
wherein each of the external electrodes includes a conductive resin layer and a plating layer formed on the conductive resin layer.

13. The chip electronic component of claim 12, wherein the conductive resin layer includes a conductive metal and a thermosetting resin.

14. The chip electronic component of claim 13, wherein the thermosetting resin is an epoxy resin.

15. The chip electronic component of claim 12, wherein the plating layer includes at least one of nickel (Ni), copper (Cu), and tin (Sn).

16. The chip electronic component of claim 1, wherein the magnetic metallic powder includes a first magnetic metallic powder and a second magnetic metallic powder, and the first magnetic metallic powder has a larger grain size than the second magnetic metallic powder.

17. The chip electronic component of claim 16, wherein the first magnetic metallic powder has a D50 within a range of 18 μm to 22 μm, and the second magnetic metallic powder has a D50 within a range of 2 μm to 4 μm.

18. The chip electronic component of claim 16, wherein a particle diameter of the first magnetic metallic powder is within a range of 11 μm to 53 μm, and a particle diameter of the second magnetic metallic powder is within a range of 0.5 μm to 6 μm.
